(19) United States
(12) Patent Application Publication
(10) Pub. No.: US 2024/0315475 A1
(43) Pub. Date: Sep. 26, 2024

(54) CARPET PAD

(71) Applicant: KUNSHAN YIJIA JU TEXTILE CO., LTD., Suzhou (CN)

(72) Inventors: Shunlin CAO, Suzhou (CN); Yi ZHANG, Suzhou (CN); Zixiang ZHAI, Suzhou (CN); Yuhao SUN, Suzhou (CN)

(73) Assignee: KUNSHAN YIJIA JU TEXTILE CO., LTD., Suzhou (CN)

(21) Appl. No.: 18/269,289

(22) PCT Filed: Nov. 29, 2021
(86) PCT No.: PCT/CN2021/133812

§ 371 Date: Jun. 23, 2023

(30) Foreign Application Priority Data
Sep. 17, 2021 (CN) 202111093631.9

(51) Int. Cl. A47G 27/02; B32B 5/02; B32B 5/12; B32B 7/06; B32B 37/06; B32B 37/08; B32B 37/16

(52) U.S. Cl. CPC A47G 27/0281; B32B 5/022; B32B 5/028; B32B 5/12; B32B 7/06; B32B 37/06; B32B 37/08; B32B 37/16; B32B 2262/0253; B32B 2307/7375; B32B 2307/744; B32B 2309/02; B32B 2310/0825; B32B 2471/02

(57) ABSTRACT

A carpet pad includes a top hook layer and a bottom anti-slip layer. An upper surface of the hook layer is provided with protruding monofilaments in a bent shape. Top ends of the protruding monofilaments are provided with bumps formed by melting/softening and then cooling the protruding monofilaments. The protruding monofilaments on the hook layer are heat-treated to make their top ends melted/softened into the small bumps. The heat-treated protruding monofilaments have a certain degree of curvature and inclination, and thus can firmly hook with various carpets above and provide a large friction force, in particular in a vertical direction. The length and density of the protruding monofilaments are reasonably designed to make the protruding monofilaments well hook and lock with the carpet above. In addition, the protruding monofilaments touch soft, and the bumps are not prickly.

### CROSS REFERENCE TO THE RELATED APPLICATIONS

This application is the national phase entry of International Application No. PCT/CN2021/133812, filed on Nov. 29, 2021, which is based upon and claims priority to Chinese Patent Application No. 202111093631.9, filed on Sep. 17, 2021, the entire contents of which are incorporated herein by reference.

### TECHNICAL FIELD

The present disclosure relates to the field of carpets in the textile industry, and in particular to a carpet pad.

### BACKGROUND

As a product for decorating homes or offices, carpets have been widely recognized by the public. However, at present, traditional carpets on the market are inconvenient to wash with water, and most of them are prone to slipping on smooth surfaces. To reduce the risk of personnel falling due to carpet slippage, it is necessary to lay an anti-slip pad underneath the carpet to hook with the carpet. Currently, there is a practice of laying an anti-slip fabric such as a polyvinyl chloride (PVC) mesh or dotted fabric beneath a traditional carpet. However, the anti-slip fabric is light, thin, easy to wrinkle, not wear-resistant, and unable to hook with the carpet above, and there is still a risk of personnel falling due to carpet slippage. Therefore, the further promotion and use of carpets are affected.

Chinese Patent Application CN201921334346. X provides an anti-slip adhesive cushion for a carpet. The anti-slip adhesive cushion for the carpet includes a bottom anti-slip and waterproof layer and a top bonding layer. The bonding layer is a single-sided fabric with multiple protruding monofilaments. Specifically, the bonding layer is a single-sided fabric with protruding monofilaments of 20 D or above, or is a single-sided structure layer formed by cutting a three-dimensional mesh structure layer. The three-dimensional mesh structure layer includes an upper warp-knitted mesh fabric, a lower warp-knitted mesh fabric, and multiple polyester (PE), polypropylene (PP) or nylon monofilaments located between the upper warp-knitted mesh fabric and the lower warp-knitted mesh fabric. The multiple PE, PP or nylon monofilaments are vertically arranged, and connect the upper warp-knitted mesh fabric with the lower warp-knitted mesh fabric. The anti-slip adhesive cushion can be combined with various carpet surface layers with moderate bonding strength to avoid slippage and warping of the carpet due to low bonding force. However, the PE, PP or nylon monofilaments in the anti-slip cushion are prone to deformation, falling off, and pricking hands after long-term use, causing unpleasant user experience. In addition, after being used together with a traditional carpet, the monofilaments in the anti-slip cushion have a low hooking force, especially in a vertical direction, and thus require a press to hook with the carpet surface layer above.

### SUMMARY

The present disclosure provides a novel carpet pad. The present disclosure solves the problems that the polyester (PE), polypropylene (PP) or nylon monofilaments in the traditional anti-slip pad and anti-slip adhesive cushion designed for a carpet have a weak hooking force and are prone to pricking hands and falling off.

The objective of the present disclosure can be achieved by the following technical solutions.

A first aspect of the present disclosure provides a carpet pad. The carpet pad includes a top hook layer and a bottom anti-slip layer, where an upper surface of the hook layer is provided with protruding monofilaments in a bent shape; and top ends of the protruding monofilaments are provided with bumps formed by melting/softening the protruding monofilaments. The protruding monofilaments on the hook layer are heat-treated to make their top ends melted/softened into the small bumps. The heat-treated protruding monofilaments have a certain degree of curvature and inclination, and thus can firmly hook with various carpets above and provide a large friction force, thereby playing a locking role on the carpet above.

In an implementation solution of the present disclosure, the protruding monofilaments have a height of 0.50-10 mm and a fineness of 18-4,400 DTEX. If the height of the protruding monofilaments is too large, it will cause the hook layer to not fit tightly with the carpet. As a result, the carpet will experience displacement under an external force, making it easy for people walking on the carpet to fall. If the height of the protruding monofilaments is too small, the protruding monofilaments will not be able to firmly hook with the carpet. If the fineness of the protruding monofilaments is too small, the protruding monofilaments are prone to fracture, and the bumps formed by heat treatment will be too small, resulting in a poor hooking effect. If the fineness of the protruding monofilaments is too large, the protruding monofilaments are not easily bent during heat treatment, resulting in failed locking, and the bumps formed during heat treatment will be too large, causing damage to the carpet during disassembly. If the fineness of the protruding monofilaments is too large, the protruding monofilaments will be excessively hard to prick hands.

In some embodiments, the protruding monofilaments have a fineness of 20-800 DTEX.

In an implementation solution of the present disclosure, there are 6-80 protruding monofilaments per square centimeter. If the density of the protruding monofilaments is too large, the multiple protruding monofilaments may not form the small bumps separately. Instead, more than one monofilament is prone to be heated together to form a large bump. The large bump will not easily enter a back gap of the carpet, making it impossible to hook with the carpet, thereby failing to achieve a locking function. If the density of the protruding monofilaments is too small, the quantity of the protruding monofilaments will be insufficient, resulting in an insufficient hooking force and degradation in the anti-slip performance.

In an implementation solution of the present disclosure, the protruding monofilaments are made of one of polyester (PE), polypropylene (PP), and nylon.

In an implementation solution of the present disclosure, the protruding monofilaments are prepared by one of knitting, tatting, tufting, flocking, and warp/weft knitting.

In an implementation solution of the present disclosure, the protruding monofilaments are prepared on the hook layer by a tufting or flocking process.

In an implementation solution of the present disclosure, the protruding monofilaments are prepared when the hook layer is prepared by a warp/weft knitting or tatting process.

In an implementation solution of the present disclosure, the hook layer has a thickness of 0.50-10 mm.

In an implementation solution of the present disclosure, the carpet pad is combined with a carpet surface layer. The heat-treated carpet pad can be freely combined with various carpets, knitted fabrics, and woven fabrics to form a combination carpet. The combination carpet can be repeatedly disassembled without damaging the weave structure of the upper and lower layers.

A second aspect of the present disclosure further provides a preparation method of the above-mentioned carpet pad, including the following steps:
A1: preparation of the hook layer: preparing a cut pile fabric with the protruding monofilaments on an upper surface to form the hook layer;
A2: heat treatment of the protruding monofilaments: melting/softening, by a heat treatment process, the top ends of the protruding monofilaments on the hook layer, and cooling the top ends of the protruding monofilaments to form the small bumps, where the protruding monofilaments are inclined irregularly and bent; and
A3: preparation of the anti-slip layer: preparing the anti-slip layer on a lower surface of the hook layer.

In an implementation solution of the present disclosure, if a weft knitting or knitting process is used, there is an intermediate layer formed between the hook layer and the anti-slip layer. The intermediate layer is made of one of a non-woven fabric, a knitted fabric, and a woven fabric. The intermediate layer has a certain level of support, comfort, flatness, and stable size, playing a supporting role.

In an implementation solution of the present disclosure, the intermediate layer is removable to directly laminate the hook layer with the anti-slip layer.

In an implementation scheme of the present disclosure, the anti-slip layer includes a foam latex layer, a thermoplastic elastomer material layer, an acrylic resin layer, an ethyl vinyl acetate (EVA) foam layer, a polyurethane (PU) foam layer, a non-woven fabric layer, a hot melt adhesive layer, cross-linked polyethylene foam (XPE) foam, an irradiated cross-linked polyethylene (IXPE) foam layer, a knitted fabric, and a woven fabric.

In an implementation scheme of the present disclosure, in step A2, the heat treatment is implemented by flame burning, and specifically includes: placing the hook layer above a flame of a flame laminating machine to melt/soften the top ends of the protruding monofilaments on the hook layer, where the flame is at 400° C.-1,000° C., 0.1-10 cm high, and approximately 1-5 cm far from the hook layer; moving, by a roller behind the flame laminating machine, the burnt fabric away from the flame; and cooling the top ends of the protruding monofilaments to form the small bumps, where the protruding monofilaments are inclined irregularly and bent.

In some embodiments, the flame is 1-5 cm high.

In an implementation solution of the present disclosure, a traction speed of the roller is 2-20 m/min.

In an implementation scheme of the present disclosure, in step A2, the heat treatment is implemented by far-infrared baking, and specifically includes: placing the hook layer in a mesh-belt type far-infrared oven to melt/soften the top ends of the protruding monofilaments on the hook layer, where a top part of the mesh-belt type far-infrared oven is provided with a far-infrared tube, and the far-infrared tube is 0-20 cm far from a carpet and configured to emit a far-infrared ray at 180° C.-800° C.; and cooling the top ends of the protruding monofilaments to form the small bumps, where the protruding monofilaments are inclined irregularly and bent.

In some embodiments, the far-infrared tube is 3-20 cm far from the carpet.

In an implementation of the present disclosure, a running speed of a mesh belt is 2-15 m/min.

In an implementation solution of the present disclosure, in step A2, the heat treatment is implemented by a heating oven, and specifically includes: placing the hook layer in the heating oven to melt/soften the top ends of the protruding monofilaments on the hook layer at 120° C.-230° C.; moving, by a mesh belt or a roller, the hook layer away from a flame; and positioning the hook layer between pressure rollers of a rolling traction device; and allowing the protruding monofilaments of the hook layer in a softened state to pass through the pressure rollers, such that the protruding monofilaments are bent and the top ends of the protruding monofilaments are formed into the small bumps.

In an implementation solution of the present disclosure, a pressure of upper and lower pressure rollers is 0.2-10 kg, adjustable by a cylinder.

In an implementation solution of the present disclosure, a running speed of the mesh belt or roller is 2-15 m/min.

In an implementation scheme of the present disclosure, the heat-treated hook layer is subjected to anti-slip, water-repellent, and moisture-proof treatment.

In an implementation scheme of the present disclosure, a sequence of steps A2 and A3 is changeable to first laminate and then heat-treat the hook layer and the anti-slip layer.

In the present disclosure, during the heat treatment process, if the flame temperature is too high, the carpet is too close to the heat source, or the traction speed is too slow, it will cause the yarn and substrate to melt directly and cause scrap. If the flame temperature is too low, the carpet is too far from the heat source, or the traction speed is too fast, it will cause the protruding monofilaments to not form the bumps.

Compared with the prior art, the present disclosure has the following beneficial effects:
1. The present disclosure performs heat treatment on the protruding monofilaments and the hook layer, causing the protruding monofilaments to bend and hook with the carpet above, thereby achieving a high bonding force, a high friction force, and firm hooking.
2. The present disclosure avoids detachment of the monofilaments on the hook layer through heat treatment.
3. The present disclosure curves the protruding monofilaments on the hook layer and passivates the surface of the small bumps, avoiding the injury of the protruding monofilaments to hands, and enhancing the locking effect of the protruding monofilament on the carpet above.

### BRIEF DESCRIPTION OF THE DRAWINGS

Other features, objectives, and advantages of the present disclosure will become more apparent by reading the detailed description of non-limiting embodiments with reference to the following drawings.

FIG. 1 is a schematic diagram of a heat-treated carpet pad;

FIG. 2 is a schematic diagram of a heat-treated carpet pad; and

FIG. 3 is a schematic diagram of a heat-treated carpet pad.

Reference Numerals: 1. hook layer with protruding monofilaments on surface; 2. intermediate layer; 3. anti-slip layer; and 4. flock layer.

### DETAILED DESCRIPTION OF THE EMBODIMENTS

The present disclosure is described in detail below with reference to the embodiments. The following embodiments will help those skilled in the art further understand the present disclosure, but will not limit the present disclosure in any way. It should be noted that those of ordinary skill in the art can further make several modifications and improvements without departing from the idea of the present disclosure. These all fall within the protection scope of the present disclosure.

### Embodiment 1

This embodiment relates to a carpet pad. As shown in FIG. 1, the carpet pad includes hook layer 1, intermediate layer 2, and anti-slip layer 3 sequentially from top to bottom. A surface of the hook layer is provided with protruding monofilaments.

The carpet pad is prepared by heat treatment as follows.

1) Material selection. A three-dimensional sandwich mesh fabric is selected, which includes an upper warp-knitted mesh fabric, a lower warp-knitted mesh fabric, and multiple polyester (PE) monofilaments located between the upper warp-knitted mesh fabric and the lower warp-knitted mesh fabric. The multiple polyester monofilaments are vertically arranged, and connect the upper warp-knitted mesh fabric with the lower warp-knitted mesh fabric. The three-dimensional sandwich mesh is cut to form a single-sided structure layer. The three-dimensional sandwich mesh fabric is specifically woven from 300 D PE monofilaments. The protruding monofilaments have a height of 3 mm.

2) Lamination of an intermediate layer. The hook layer is taken as a substrate. 300 g/m² of PE staple fibers are laid on a lower surface of the substrate, and then the hook layer is subjected to needle punching by an RY1-4000 non-woven fabric needle punching machine. The needle punching process involves the following parameters: needle density: 15,000 needles/m²: stroke frequency: 350 times/min; feeding speed: 1.1 m/min; and needle stroke: 1.10 cm.

3) Heat treatment. The hook layer with the protruding monofilaments on the surface is conveyed to a flame laminating machine through a mesh belt. The hook layer is passed through the flame laminating machine at a speed of 20 m/min. The surface of the hook layer is 4 cm far from a flame that is at 730° C. and is 4 cm high. The protruding monofilaments are burnt by the flame, and are moved away from the flame by a roller. After the heat treatment, the protruding monofilaments have a height of 1-2 mm. Top ends of the protruding filaments are cooled to form small bumps.

4) Preparation of the anti-slip layer. Anti-slip treatment is performed using a thermoplastic elastomer on a back of the intermediate layer.

5) Cutting. After the anti-slip treatment, the carpet pad is cut according to its size.

### Embodiment 2

This embodiment relates to a heat-treated carpet pad. As shown in FIG. 1, the carpet pad includes hook layer 1, intermediate layer 2, and anti-slip layer 3 sequentially from top to bottom. A surface of the hook layer is provided with protruding monofilaments.

The carpet pad is prepared by heat treatment as follows.

1) Material selection. A PE fabric with protruding monofilaments on a surface is selected, which is prepared by a tatting process. The protruding monofilaments have a height of 5 mm and a fineness of 400 D.

2) Lamination process. The woven fabric is laminated with a non-woven fabric through a hot melt adhesive.

3) Heat treatment. The laminated fabric prepared by the above steps is put into a mesh-belt type oven, with the protruding monofilament facing upwards. A top part of the oven is provided with a far-infrared tube. The far-infrared tube is 6 cm far from a mesh belt, and is at 800° C. During high-temperature irradiation, bent small bumps are formed on a surface of a three-dimensional sandwich mesh fabric that is cut. The mesh belt runs at a speed of 10 m/min. The protruding monofilaments are moved away by a roller. After the heat treatment, the protruding monofilaments have a height of 1-3 mm.

4) Preparation of the anti-slip layer. Anti-slip treatment is performed using foam latex on a back of the non-woven fabric.

5) Cutting. After the anti-slip treatment, the carpet pad is cut according to its size.

6) Hemming. The cut carpet pad is hemmed.

### Embodiment 3

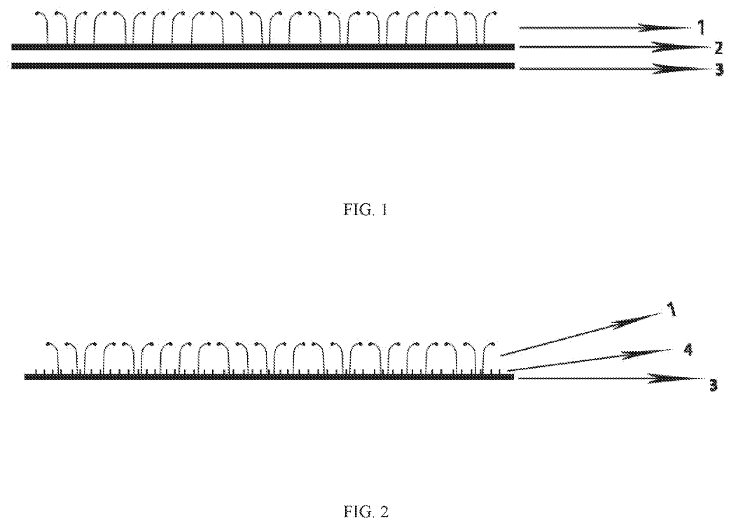

This embodiment relates to a heat-treated carpet pad. As shown in FIG. 2, the carpet pad includes hook layer 1, flock layer 4, and anti-slip layer 3 sequentially from top to bottom. A surface of the hook layer is provided with protruding monofilaments.

The carpet pad is prepared by heat treatment as follows.

1) Selection of a non-woven fabric. A warp-knitted PE woven fabric with a weight of 85 g/m² and a density of 114/63 is taken as a substrate. 140 g/m² PE staple fibers are laid on the substrate, and the substrate is conveyed to an RY1-4000 non-woven fabric needle punching machine. A fiber mesh of the fabric is repeatedly punctured by a needle of the needle punching machine to form a 3 mm high pile layer on one side of the substrate, thereby forming a composite substrate. The needle punching process involves the following parameters: needle density: 15,000 needles/m², stroke frequency 450 times/min; feeding speed 1.8 m/min; and needle stroke 2.1 cm.

2) Tufting process. 20 D polypropylene (PP) monofilaments are tufted on the non-woven fabric. The protruding monofilaments have a height of 6 mm.

3) Heat treatment. The tufted fabric is conveyed to a flame laminating machine through a mesh belt. The tufted fabric is passed through the flame laminating machine at a speed of 16 m/min, and the surface of the tufted fabric is 4 cm far from a flame that is at 780° C. and 3 cm high. After the burning, the fabric is moved away from the flame by a roller. After the heat treatment, the monofilaments have a height of 2-4 mm.

4) Preparation of the anti-slip layer. Anti-slip treatment is performed using an ethyl vinyl acetate (EVA) foam layer on a back of the non-woven fabric.

5) Cutting. After the anti-slip treatment, the carpet pad is cut according to its size.

6) Hemming. The cut carpet pad is hemmed.

### Embodiment 4

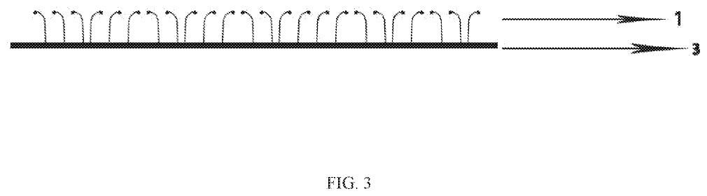

This embodiment relates to a heat-treated carpet pad. As shown in FIG. 3, the carpet pad includes hook layer 1 and anti-slip layer 3 sequentially from top to bottom. A surface of the hook layer is provided with protruding monofilaments.

The carpet pad is prepared by heat treatment as follows.

1) Material selection. A warp-knitted nylon fabric with cut protruding monofilaments is selected. The protruding monofilaments have a height of 4 mm and a fineness of 2,000 D.

2) Heat treatment. The nylon fabric is conveyed to a flame laminating machine through a mesh belt. The nylon fabric is passed through the flame laminating machine at a speed of 19 m/min. A surface of the nylon fabric is 3 cm far from a flame that is at 690° C. and 3 cm high. After burning, the nylon fabric is moved away from the flame by a roller. After the heat treatment, the protruding monofilaments have a height of 1-3 mm.

3) Preparation of the anti-slip layer. Anti-slip treatment is performed using a thermoplastic elastomer.

4) Cutting. After the anti-slip treatment, the carpet pad is cut according to its size.

### Embodiment 5

This embodiment relates to a heat-treated carpet pad. As shown in FIG. 1, the carpet pad includes hook layer 1, intermediate layer 2, and anti-slip layer 3 sequentially from top to bottom. A surface of the hook layer is provided with protruding monofilaments.

The carpet pad is prepared by heat treatment as follows.

1) Material selection. A warp-knitted PE fabric with cut protruding monofilaments is selected. The protruding monofilaments have a height of 5 mm and a fineness of 500 D.

2) Heat treatment. The PE fabric is conveyed to a flame laminating machine through a mesh belt. The PE fabric is passed through the flame laminating machine at a speed of 20 m/min. A surface of the PE fabric is 2 cm far from a flame that is at 730° C. and 4 cm high. After burning, the PE fabric is moved away from the flame by a roller. After the heat treatment, the protruding monofilaments have a height of 2-4 mm.

3) Needle puncturing process. The above fabric is taken as a substrate. 300 g/m² of PE staple fibers are laid on the substrate, and then the fabric is subjected to needle punching by an RY1-4000 non-woven fabric needle punching machine. The needle punching process involves the following parameters: needle density: 15,000 needles/m²; stroke frequency: 350 times/min; feeding speed: 1.1 m/min; and needle stroke: 1.10 cm.

4) Preparation of the anti-slip layer. Anti-slip treatment is performed using a hot melt adhesive on a back of the non-woven fabric.

5) Cutting. After the anti-slip treatment, the carpet pad is cut according to its size.

### Embodiment 6

This embodiment relates to a heat-treated carpet pad. As shown in FIG. 3, the carpet pad includes hook layer 1 and anti-slip layer 3 sequentially from top to bottom. A surface of the hook layer is provided with protruding monofilaments.

The carpet pad is prepared by heat treatment as follows.

1) Tufting process. 260 D PE monofilaments are tufted on the non-woven fabric. The protruding monofilaments have a height of 5 mm.

2) Heat treatment. The PE monofilaments are treated by tufting and cutting processes to form a fabric with protruding monofilaments. The fabric with protruding monofilaments is conveyed into an oven through a mesh belt, and is passed through the oven at a speed of 12 m/min to melt/soften the protruding monofilaments on the hook layer at 180° C. Then the fabric is moved out of the oven through a roller behind the oven, and is positioned between upper and lower pressure rollers of a rolling traction device. The protruding monofilaments of the hook layer in a softened state are passed through the pressure rollers, and are thus bent. The pressure rollers apply a pressure of 3 kg.

3) Preparation of the anti-slip layer. Anti-slip treatment is performed using a thermoplastic elastomer.

4) Cutting. After the anti-slip treatment, the carpet pad is cut according to its size.

### Comparative Example 1

This comparative example relates to a carpet pad, which is prepared by a method basically the same as the preparation method in Embodiment 1, except that the protruding monofilaments have a height of 15 mm.

The carpet pad is prepared by heat treatment as follows.

1) Material selection. A three-dimensional sandwich mesh fabric is selected, which includes an upper warp-knitted mesh fabric, a lower warp-knitted mesh fabric, and multiple polyester (PE) monofilaments located between the upper warp-knitted mesh fabric and the lower warp-knitted mesh fabric. The multiple polyester monofilaments are vertically arranged, and connect the upper warp-knitted mesh fabric with the lower warp-knitted mesh fabric. The three-dimensional sandwich mesh is cut to form a single-sided structure layer. The three-dimensional sandwich mesh fabric is specifically woven from 300 D PE monofilaments. The protruding monofilaments have a height of 15 mm.

2) Lamination of an intermediate layer. The hook layer is taken as a substrate. 300 g/m² of PE staple fibers are laid on a lower surface of the substrate, and then the hook layer is subjected to needle punching by an RY1-4000 non-woven fabric needle punching machine. The needle punching process involves the following parameters: needle density: 15,000 needles/m²: stroke frequency: 350 times/min; feeding speed: 1.1 m/min; and needle stroke: 1.10 cm.

3) Heat treatment. The hook layer with the protruding monofilaments on the surface is conveyed to a flame laminating machine through a mesh belt. The hook layer is passed through the flame laminating machine at a speed of 20 m/min. The surface of the hook layer is 4 cm far from a flame that is at 730° C. and is 5 cm high. The protruding monofilaments are burnt by the flame, and are moved away from the flame by a roller. After the heat treatment, the protruding monofilaments have a height of 15 mm. Top ends of the protruding filaments are cooled to form small bumps.

4) Preparation of the anti-slip layer. Anti-slip treatment is performed using a thermoplastic elastomer on a back of the intermediate layer.

5) Cutting. After the anti-slip treatment, the carpet pad is cut according to its size.

### Comparative Example 2

This comparative example relates to a carpet pad, which is prepared by a method basically the same as the preparation method in Embodiment 1, except that the protruding monofilaments have a height of 0.3 mm.

The carpet pad is prepared by heat treatment as follows.

1) Material selection. A three-dimensional sandwich mesh fabric is selected, which includes an upper warp-knitted mesh fabric, a lower warp-knitted mesh fabric, and multiple polyester (PE) monofilaments located between the upper warp-knitted mesh fabric and the lower warp-knitted mesh fabric. The multiple polyester monofilaments are vertically arranged, and connect the upper warp-knitted mesh fabric with the lower warp-knitted mesh fabric. The three-dimensional sandwich mesh is cut to form a single-sided structure layer. The three-dimensional sandwich mesh fabric is specifically woven from 300 D PE monofilaments. The protruding monofilaments have a height of 0.3 mm.

2) Lamination of an intermediate layer. The hook layer is taken as a substrate. 300 g/m² of PE staple fibers are laid on a lower surface of the substrate, and then the hook layer is subjected to needle punching by an RY1-4000 non-woven fabric needle punching machine. The needle punching process involves the following parameters: needle density: 15,000 needles/m²; stroke frequency: 350 times/min; feeding speed: 1.1 m/min; and needle stroke: 1.10 cm.

3) Heat treatment. The hook layer with the protruding monofilaments on the surface is conveyed to a flame laminating machine through a mesh belt. The hook layer is passed through the flame laminating machine at a speed of 20 m/min. The surface of the hook layer is 4 cm far from a flame that is at 730° C. and is 5 cm high. The protruding monofilaments are burnt by the flame, and are moved away from the flame by a roller. After the heat treatment, the protruding monofilaments have a height of 0.1-0.3 mm. Top ends of the protruding filaments are cooled to form small bumps.

4) Preparation of the anti-slip layer. Anti-slip treatment is performed using a thermoplastic elastomer on a back of the intermediate layer.

5) Cutting. After the anti-slip treatment, the carpet pad is cut according to its size.

### Comparative Example 3

This comparative example relates to a carpet pad, which is prepared by a method basically the same as the preparation method in Embodiment 1, except that the protruding monofilaments have a fineness of 10 D.

The carpet pad is prepared by heat treatment as follows.

1) Material selection. A three-dimensional sandwich mesh fabric is selected, which includes an upper warp-knitted mesh fabric, a lower warp-knitted mesh fabric, and multiple polyester (PE) monofilaments located between the upper warp-knitted mesh fabric and the lower warp-knitted mesh fabric. The multiple polyester monofilaments are vertically arranged, and connect the upper warp-knitted mesh fabric with the lower warp-knitted mesh fabric. The three-dimensional sandwich mesh is cut to form a single-sided structure layer. The three-dimensional sandwich mesh fabric is specifically woven from 1 D PE monofilaments. The protruding monofilaments have a height of 3 mm.

2) Lamination of an intermediate layer. The hook layer is taken as a substrate. 300 g/m² of PE staple fibers are laid on a lower surface of the substrate, and then the hook layer is subjected to needle punching by an RY1-4000 non-woven fabric needle punching machine. The needle punching process involves the following parameters: needle density: 15,000 needles/m²; stroke frequency: 350 times/min; feeding speed: 1.1 m/min; and needle stroke: 1.10 cm.

3) Heat treatment. The hook layer with the protruding monofilaments on the surface is conveyed to a flame laminating machine through a mesh belt. The hook layer is passed through the flame laminating machine at a speed of 20 m/min. The surface of the hook layer is 4 cm far from a flame that is at 730° C. and is 5 cm high. The protruding monofilaments are burnt by the flame, and are moved away from the flame by a roller. After the heat treatment, the protruding monofilaments have a height of 0.1-0.3 mm. Top ends of the protruding filaments are cooled to form small bumps.

4) Preparation of the anti-slip layer. Anti-slip treatment is performed using a thermoplastic elastomer on a back of the intermediate layer.

5) Cutting. After the anti-slip treatment, the carpet pad is cut according to its size.

### Comparative Example 4

This comparative example relates to a carpet pad, which is prepared by a method basically the same as the preparation method in Embodiment 1, except that the protruding monofilaments have a fineness of 5,000 D.

The carpet pad is prepared by heat treatment as follows.

1) Material selection. A three-dimensional sandwich mesh fabric is selected, which includes an upper warp-knitted mesh fabric, a lower warp-knitted mesh fabric, and multiple polyester (PE) monofilaments located between the upper warp-knitted mesh fabric and the lower warp-knitted mesh fabric. The multiple polyester monofilaments are vertically arranged, and connect the upper warp-knitted mesh fabric with the lower warp-knitted mesh fabric. The three-dimensional sandwich mesh is cut to form a single-sided structure layer. The three-dimensional sandwich mesh fabric is specifically woven from 210 D PE monofilaments. The protruding monofilaments have a height of 3 mm.

2) Lamination of an intermediate layer. The hook layer is taken as a substrate. 300 g/m² of PE staple fibers are laid on a lower surface of the substrate, and then the hook layer is subjected to needle punching by an RY1-4000 non-woven fabric needle punching machine. The needle punching process involves the following parameters: needle density: 15,000 needles/m²; stroke frequency: 350 times/min; feeding speed: 1.1 m/min; and needle stroke: 1.10 cm.

3) Heat treatment. The hook layer with the protruding monofilaments on the surface is conveyed to a flame laminating machine through a mesh belt. The hook layer is passed through the flame laminating machine at a speed of 20 m/min. The surface of the hook layer is 4 cm far from a flame that is at 730° C. and is 5 cm high. The protruding monofilaments are burnt by the flame, and are moved away from the flame by a roller. After the heat treatment, the protruding monofilaments have a height of 0.1-0.3 mm. Top ends of the protruding filaments are cooled to form small bumps.

4) Preparation of the anti-slip layer. Anti-slip treatment is performed using a thermoplastic elastomer on a back of the intermediate layer.

5) Cutting. After the anti-slip treatment, the carpet pad is cut according to its size.

### Performance Tests

### I. Firmness Test

1. A 30 cm×30 cm heat-treated carpet pad in Embodiment 1 was overlapped with a 30 cm×30 cm knitted fabric. The overlapped fabric was rolled twice with a 6 kg roller, and was subjected to three lateral peel force tests by a tensile testing machine. The test results were 214.87 Newton, 235.213 Newton, and 198.186 Newton, respectively.

2. A 30 cm×30 cm anti-slip adhesive cushion provided by Chinese Patent Application CN201921334346. X was overlapped with a 30 cm×30 cm knitted fabric. The overlapped fabric was rolled twice with a 6 kg roller, and was subjected to three lateral peel force tests by a tensile testing machine. The test results were 52.128 Newton, 52.128 Newton, and 53.252 Newton.

3. A 30 cm×30 cm heat-treated carpet pad in Embodiment 1 was overlapped with a 30 cm×30 cm knitted fabric. The overlapped fabric was rolled twice with a 6 kg roller, and was subjected to three upward peel force tests by a tensile testing machine. The test results were 5.258 Newton, 5.587 Newton, and 6.487 Newton, respectively.

4. A 30 cm×30 cm anti-slip adhesive cushion provided by Chinese Patent Application CN201921334346. X was overlapped with a 30 cm×30 cm knitted fabric. The overlapped fabric was rolled twice with a 6 kg roller, and was subjected to three upward peel force tests by a tensile testing machine. The test results were 1.387 Newton, 1.325 Newton, and 1.467 Newton.

The tests show that compared to the anti-slip adhesive cushion provided by Chinese Patent Application CN 201921334346. X, the heat-treated anti-slip and moisture-proof carpet pad of the present disclosure has a greater bonding force, a greater friction force, and greater firmness.

### II. Disassembly Life Test

1. A 30 cm×30 cm heat-treated carpet pad in Embodiment 3 and a carpet surface layer were overlapped with each other, rolled twice with a 6 kg roller, and subjected to 20 longitudinal and transverse disassembly tests by a tensile testing machine. The surface was intact without damage, and there were no monofilaments falling off.

2. A 30 cm×30 cm heat-treated carpet pad provided by Chinese Patent Application CN201921334346.X and a carpet surface layer were overlapped with each other, rolled twice with a 6 kg roller, and subjected to 20 longitudinal and transverse disassembly tests by a tensile testing machine. There were some monofilaments falling off the surface.

The tests show that compared to that provided by Chinese Patent Application CN2019107593, the heat-treated carpet pad of the present disclosure has a greater bonding force and greater firmness, and significantly reduces the falling off of monofilaments.

### III. Bonding Force Test

A 30 cm×30 cm heat-treated carpet pad in Embodiment 1 and a carpet surface layer were overlapped with each other, and were moved back and forth by a hand. The carpet pad and the carpet were firmly bonded, and the carpet was not displaced.

A 30 cm×30 cm heat-treated carpet pad in Comparative Example 1 and a carpet surface layer were overlapped with each other, and were moved back and forth by a hand. The carpet was significantly displaced and could not be fixed.

A 30 cm×30 cm heat-treated carpet pad in Comparative Example 2 and a carpet surface layer were overlapped with each other, and were moved back and forth by a hand. Due to the small height of the protruding monofilaments, the hooking effect of the protruding monofilaments on the carpet was poor.

A 30 cm×30 cm heat-treated carpet pad in Comparative Example 3 and a carpet surface layer were overlapped with each other, and were moved back and forth by a hand. The protruding monofilaments were too thin to support and fix the carpet.

A 30 cm×30 cm heat-treated carpet pad in Comparative Example 4 and a carpet surface layer were overlapped with each other, and were moved back and forth by a hand. The protruding monofilaments were too thick, posing a risk of pricking or even hurting.

The specific embodiments of the present disclosure are described above. It should be understood that the present disclosure is not limited to the above specific implementations, and a person skilled in the art can make various variations or modifications within the scope of the claims without affecting the essence of the present disclosure.

What is claimed is:

1. A carpet pad, comprising a top hook layer and a bottom anti-slip layer, wherein an upper surface of the top hook layer is provided with protruding monofilaments in a bent shape; and top ends of the protruding monofilaments are provided with bumps formed by melting/softening the protruding monofilaments.

2. The carpet pad according to claim 1, wherein the protruding monofilaments have a height of 0.50 mm-10 mm and a fineness of 18 DTEX-4,400 DTEX.

3. The carpet pad according to claim 1, wherein the upper surface of the top hook layer is provided with 6-80 protruding monofilaments per square centimeter.

4. The carpet pad according to claim 1, wherein the protruding monofilaments are made of one selected from the group consisting of polyester (PE), polypropylene (PP), and nylon.

5. The carpet pad according to claim 1, wherein the top hook layer has a thickness of 0.50 mm-10 mm.

6. The carpet pad according to claim 1, wherein the protruding monofilaments are prepared by one selected from the group consisting of knitting, tufting, flocking, tatting, and warp/weft knitting.

7. The carpet pad according to claim 1, wherein the carpet pad is detachably combined with a carpet surface layer.

8. A preparation method of the carpet pad according to claim 1, comprising the following steps:
A1: preparation of the top hook layer: preparing a cut pile fabric with the protruding monofilaments on an upper surface to form the top hook layer;
A2: heat treatment of the protruding monofilaments: melting/softening, by a heat treatment process, the top ends of the protruding monofilaments on the top hook layer, and cooling the top ends of the protruding monofilaments to form the small bumps, wherein the protruding monofilaments are inclined irregularly and bent; and
A3: preparation of the bottom anti-slip layer: preparing the bottom anti-slip layer on a lower surface of the top hook layer.

9. The preparation method according to claim 8, wherein in step A2, the heat treatment is implemented by flame burning, and specifically comprises: placing the top hook layer above a flame of a flame laminating machine to melt/soften the top ends of the protruding monofilaments on the top hook layer, wherein the flame is at 400° C.-1,000° C., 0.1 cm-10 cm high, and approximately 1-cm-5 cm far from the top hook layer; moving, by a roller behind the flame laminating machine, the burnt fabric away from the flame; and cooling the top ends of the protruding monofilaments to form the small bumps, wherein the protruding monofilaments are inclined irregularly and bent.

10. The preparation method according to claim 8, wherein in step A2, the heat treatment is implemented by far-infrared baking, and specifically comprises: placing the top hook layer in a mesh-belt type far-infrared oven to melt/soften the top ends of the protruding monofilaments on the top hook layer, wherein a top part of the mesh-belt type far-infrared oven is provided with a far-infrared tube, and the far-infrared tube is 0 cm-20 cm far from a carpet and configured to emit a far-infrared ray at 180° C.-800° C.; and cooling the top ends of the protruding monofilaments to form the small bumps, wherein the protruding monofilaments are inclined irregularly and bent.

11. The preparation method according to claim 8, wherein in step A2, the heat treatment is implemented by a heating oven, and specifically comprises: placing the top hook layer in the heating oven to melt/soften the top ends of the protruding monofilaments on the top hook layer at 120° C.-230° C.; moving, by a mesh belt or a roller, the top hook layer away from a flame; and positioning the top hook layer between pressure rollers of a rolling traction device; and allowing the protruding monofilaments of the top hook layer in a softened state to pass through the pressure rollers, such that the protruding monofilaments are bent and the top ends of the protruding monofilaments are formed into the small bumps.
